(19) United States
(12) Patent Application Publication
(10) Pub. No.: US 2011/0142307 A1
(43) Pub. Date: Jun. 16, 2011

(54) VERTEBRAL FRACTURE PREDICTION

(75) Inventors: Anarta Ghosh, Dublin (IE); Mads Nielsen, Dragor (DK); Morten A. Karsdal, O Copenhagen (DK); Claus Christiansen, Morcote (CH); Paola Pettersen, Vallo (DK); Marleen De Bruijne, Rotterdam (NL)

(73) Assignee: NORDIC BIOSCIENCE IMAGING A/S, Herlev (DK)

(21) Appl. No.: 12/936,790

(22) PCT Filed: Apr. 9, 2009
(86) PCT No.: PCT/EP09/54294

§ 371 Date: Dec. 27, 2010

(30) Foreign Application Priority Data
Apr. 10, 2008 (GB) 0806509.6

(51) Int. Cl. G06K 9/62

(52) U.S. Cl. 382/128

(57) ABSTRACT

The risk of future fracture or deformity of vertebrae of a spine may be estimated by processing an image of at least one vertebra of a spine to compare data representing the appearance of the at least one vertebra with a statistical model of a corresponding part of a spine, the statistical model being formed from data representing images of spines for which information about the degree of fracture or deformity of each spine at a subsequent time is known, and deriving a measure of the similarity between the at least one vertebra of the spine and the model, which measure is representative of the likelihood that the spine will subsequently sustain a fracture or become deformed.

The present invention relates to a method of estimating the risk of future fracture or deformity of vertebrae of a spine.

Osteoporosis and related complications, such as fragility fracture, remain the centre of major healthcare problems worldwide.

Vertebral fractures are the most common type of osteoporotic fractures contributing with approximately 750,000 cases per year. Presence of vertebral fractures has been associated with acute and chronic pain, impaired life quality, as well as with shortened life expectancy. There is, therefore, a continuing interest in identifying independent predictors of vertebral fractures that could facilitate the recognition of high-risk patients, who would benefit the most from early prevention.

Much of the burden of osteoporosis can potentially be avoided if individuals at risk of developing fragility fractures are identified and appropriate interventions (both preventative and therapeutic) are made in a timely manner.

It has been found that the aetiology of a vertebral fracture is multi-factorial and cannot be solely explained by the level and distribution of bone mineral density (BMD). Structural failure only occurs when the load exposing the vertebra exceeds its load-bearing capacity. In the past years, there has been increasing attention focused on the better understanding of how the size, shape and appearance of adjacent vertebrae (that considerably influence the load distribution in a spine) influence fracture risk. It has also been noticed (in this context) that the presence of fractures in the spine exerts a strong inclination to sustain subsequent fractures, independently of BMD and other risk fractures.

Radiographic diagnosis of vertebral fractures is considered to be the best way to identify and confirm the presence of vertebral fractures and numerous methods have been proposed to quantify vertebral body shape and to identify deformities. In particular, several semi-quantitative morphometry methods have been devised for identifying vertebral fractures.

Semi-quantitative morphometry may be used to distinguish an osteoporotic change in vertebral height from another disease. A known semi-quantitative method grades the vertebrae into a few categories based on visual inspection. The vertebrae are graded as normal (grade 0), mildly deformed (grade 1: reduction of 20 to 25% of height and 10 to 20% of apparent vertebral area), moderately deformed (grade 2: reduction of 25 to 40% of height and 20 to 40% of apparent vertebral area), and severely deformed (grade 3: reduction of more than 40% of height and apparent vertebral area). In addition to the height reductions, alterations in the shape relative to adjacent vertebrae and expected normal appearance are taken into account. These methods have limited sensitivity and the classification could in borderline cases rather arbitrarily be considered normal or fractured.

In Smyth et al (Radiology, May 1999, pp 571-578), a point distribution model is used to compare a given vertebra shape, as observed in an image of a spine, directly to shapes of vertebrae found in other images to decide whether the given vertebra is fractured or not. A statistical classifier that is trained on examples of healthy and fractured vertebrae is used to distinguish between the two classes.

The studies described above, however, focus only on identifying osteoporotic fractures when they arise, by which time it is too late to take preventative action. No systematic method for identifying the risk of a spine sustaining fractures or deformities has yet been proposed.

According to a first aspect of the present invention, there is provided a method of estimating the risk of future fracture and/or deformity of vertebrae of a spine by processing data derived from an image of at least one vertebra of a spine, comprising the steps of comparing data representing the appearance of the at least one vertebra with a statistical model of a corresponding part of a spine, the statistical model being formed from data representing images of spines for which information about the degree of fracture or deformity of each spine at a subsequent time is known; and deriving a measure of the similarity between the at least one vertebra of the spine and the model, wherein said measure is representative of the likelihood that the spine will subsequently sustain a fracture or become deformed.

It has not previously been known that the shape of a spine that is likely to become fractured or deformed changes some time before a fracture or deformity is incurred. By forming a model using spines at baseline for which the future fracture/deformity outcome is known, it is possible to obtain a measure representative of the likelihood that a spine will sustain a fracture and/or deformity in the future. It is therefore possible to determine, at an early stage, the risk of the spine of a person becoming fractured or deformed, or in the case where the spine is already fractured or deformed, becoming more fractured or deformed.

The method may be used to initiate a course of treatment to prevent or to reduce osteoporosis of the spine when the measure is above or below a certain level.

The method may additionally or alternatively be used at the entry point for a clinical study. For example, the method may be used to reduce the number of people required for a study relating to osteoporosis by identifying those people at risk of sustaining future vertebral fractures and/or deformity.

The method may also be used to mark the endpoint for participants of a clinical study. For example, the method may be used to identify participants in a clinical trial who are at increased risk of suffering a vertebral fracture or spinal deformity. Thus, a person who may be at increased risk may be exempted from a study prior to suffering a vertebral fracture.

The statistical model may be a one-class model or a two-class model. This may be dependent on the amount of training data available.

In an embodiment, the statistical model is formed from data representing images of unfractured and undeformed spines for which it is known whether vertebrae of said unfractured and undeformed spines remain unfractured and/or undeformed until the subsequent time.

Preferably, the statistical model is trained to distinguish between a class of unfractured and undeformed spines that remained unfractured and undeformed until said subsequent time and a class of unfractured and undeformed spines that sustained one or more fractures or became deformed by said subsequent time.

More preferably, the measure is representative of the probability that the spine belongs to the class of unfractured and undeformed spines that sustained one or more fractures or became deformed by said subsequent time. In a preferred embodiment, by obtaining a measure representative of the probability that a spine belongs to a class of spines that sustained fractures or became deformed by a subsequent time, it is possible to estimate the likelihood or risk that an unfractured and undeformed spine being examined will subsequently sustain a fracture or become deformed.

In an alternative embodiment, the statistical model is formed from data representing images of fractured and/or deformed spines for which it is known whether the fractured and/or deformed spines sustain further fractures and/or become more deformed by the subsequent time. This embodiment may be used to assess the likelihood of a spine that is already fractured and/or deformed subsequently sustaining further fractures or becoming more deformed.

Preferably, the statistical model is trained to distinguish between a class of fractured and/or deformed spines that do not sustain further fractures or become more deformed by said subsequent time and a class of fractured and/or deformed spines that sustain further fractures or become more deformed by said subsequent time.

More preferably, the measure is representative of the probability that the spine belongs to the class of fractured and/or deformed spines that sustain further fractures or become more deformed by said subsequent time.

The two-class models described above may be trained using any known method that will enable distinction between the two classes. Preferably, the model is trained using supervised learning. More preferably, the model is trained using discriminant analysis. The discriminant analysis may be in the form of penalised discriminant analysis or by using robust estimates for the covariance matrix. However, in a preferred embodiment, the method uses a form of regularised discriminant analysis. Further information about the forms of training that may be used can be found in the paper by De la Torre, F. and Black, M. J “A framework for robust subspace learning”, International Journal of Computer Vision, Vol. 54, Issue 1-3, pp 117-142, August-October 2003.

The one-class statistical model may be trained using unfractured and undeformed spines that remained unfractured and undeformed until said subsequent time. Using this embodiment, the measure may be representative of the difference between the spine and the statistical model and the likelihood that the spine will sustain a fracture and become deformed increases as the measure increases.

In an alternative one-class embodiment, the statistical model is trained using unfractured and/or undeformed spines that sustain fractures or become deformed by said subsequent time. Preferably the measure is representative of the difference between the spine and the statistical model and the likelihood that the spine will sustain a fracture and/or become deformed increases as the measure decreases.

When using the above described one-class models, the spine being examined will preferably be unfractured at baseline. It will be appreciated that alternative models using spines that are fractured and/or deformed at baseline may also be used to provide a measure of the likelihood that a spine being examined that is fractured and/or deformed at baseline will go on to sustain further fractures or become more deformed.

In a preferred embodiment, processing data comprises processing data representing the appearance of two or more adjacent vertebrae of a spine and wherein said measure represents the likelihood that at least one of said vertebrae will subsequently sustain a fracture and/or become deformed.

Preferably data representing the appearance of the at least one vertebra comprises data representing one or more of the shape, image texture, thickness of cortical bone visible in the image and image intensity.

In an alternative preferred embodiment, data representing the appearance of the at least one vertebra comprises data representing the shape of the at least one vertebra. More preferably, data representing the appearance of the at least one vertebra further comprises one or more of the image texture, thickness of cortical bone visible in the image and image intensity.

Preferably, comparing the data with the statistical model comprises fitting the model to the data.

Although the invention has principally been defined as a method of extracting significant information from a digital image, it is of course equally applicable as an instruction set for a computer for carrying out a said method or as a suitably programmed computer.

The present invention also extends to a method of characterising an image of at least one vertebra of a spine to determine if the image belongs to a class of images of spines for which the degree of fracture and/or deformity did not change by a subsequent time, comprising the steps of comparing data representing the appearance of the at least one vertebra with a statistical model of a corresponding part of spine, the statistical model being formed from data representing images of spines for which it is known whether vertebrae of the spines sustained fractures or became deformed by the subsequent time; and deriving a measure of the similarity between the data representing the at least one vertebra and the statistical model, wherein the measure is representative of the likelihood that the image of the at least one vertebra belongs to the class of images of spines for which the degree of fracture and/or deformity did not change by the subsequent time.

The invention will be further described and illustrated with reference to specific embodiments thereof with reference being made to the accompanying drawings, in which:

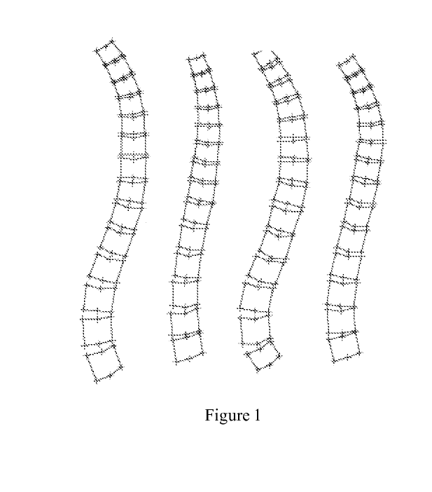

FIG. 1 shows an example of randomly selected spine shapes, two from the group maintaining skeletal integrity and two from the group known to sustain a fracture;

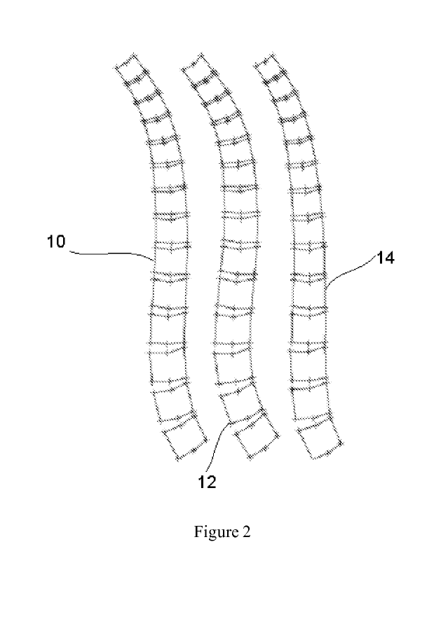

FIG. 2 shows an example of the shape variations in spines across the classification boundary used in an embodiment of the present invention;

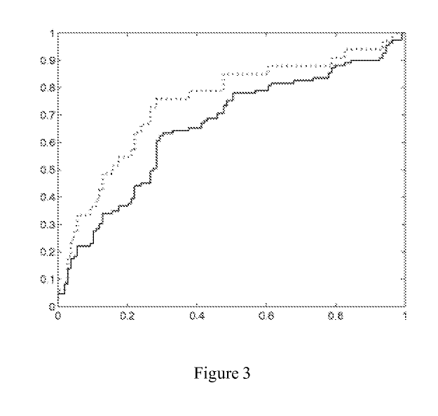

FIG. 3 shows an example of ROC curves obtained for fracture and/or deformity prediction using discriminant analysis in accordance with an embodiment of the present invention;

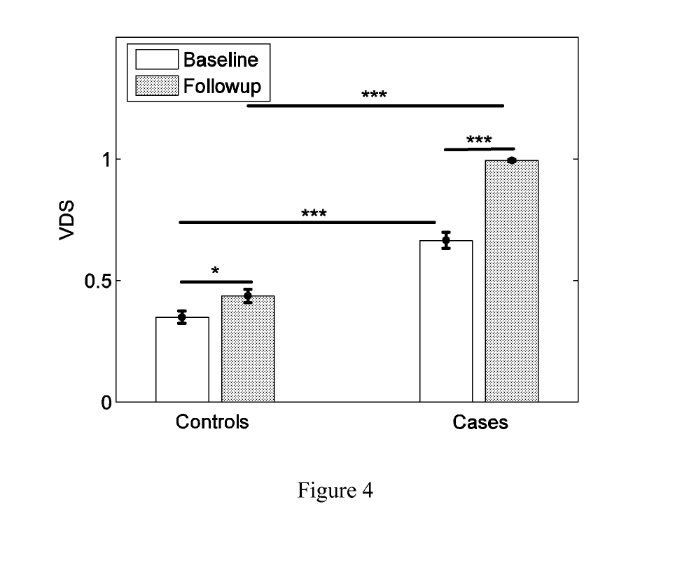

FIG. 4 shows as statistical analysis performed n a further example according to the invention;

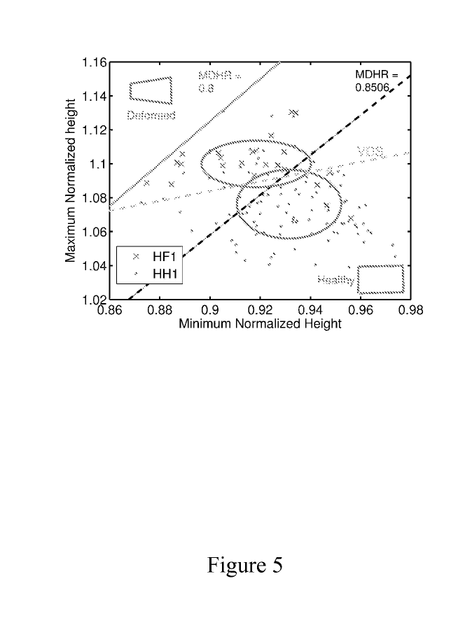

FIG. 5 shows the distribution of the shapes of the vertebrae studied in said second example plotted in a two dimensional space defined by their minimum and maximum normalised heights;

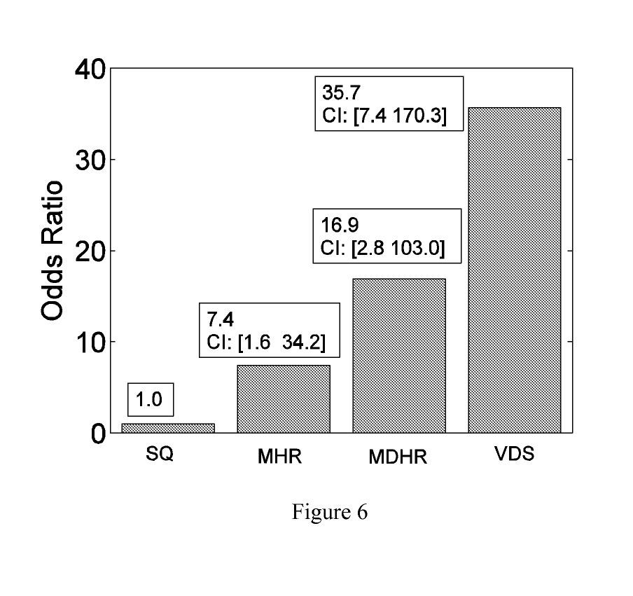

FIG. 6 shows the odds ratios for a measure according to the invention (VDS) and alternative measures; and

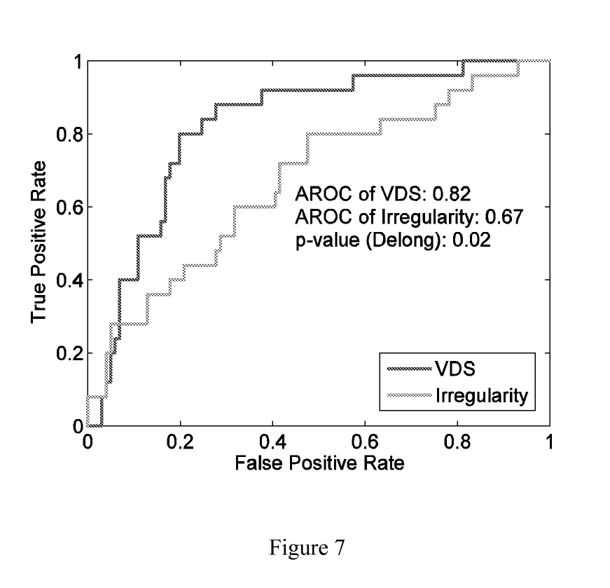

FIG. 7 shows ROC curves for the embodiment of the invention used in the second example thereof and a previously best performing established measure.

The present invention will hereinafter be described with particular reference to the analysis of x-ray images of vertebrae of a spine. It will, however, be appreciated that the described method could be applied to other medical images of a spine for example, DXA, Computer Tomography (CT), Ultrasound, or Magnetic Resonance.

The preferred method is to estimate the likelihood that a patient will develop vertebral fracture or deformity in the future, and, where a spine is already fractured or deformed, the likelihood that it will become further deformed or that further fractures will be sustained. The two main steps of the method are described below.

The first step is to prepare a statistical model using images of spines where the degree of fracture and/or deformity of each spine at a subsequent time is known.

The model may be a one-class model or a two-class model trained to distinguish between the two classes.

The one-class model may be based on: spines that are unfractured and undeformed at baseline that are known to remain unfractured and undeformed until a subsequent time; spines that are unfractured and undeformed at baseline that are known to go on to sustain one or more fractures or become deformed by a subsequent time; spines that are fractured and/or deformed at baseline that are known to maintain the same degree of fracture and/or deformity until a subsequent time; and spines that are fractured and/or deformed at baseline and that are known to become more fractured or deformed by a subsequent time.

The two-class model may be based on a combination of these classes of spine. In a first embodiment, the two-class model may be based on all spines that are unfractured and undeformed at baseline and the model will be trained to differentiate between those unfractured and undeformed spines that are likely to remain unfractured/undeformed and those that go on to sustain vertebral fractures or deformity. In an alternative two-class embodiment, the spines used to make the model may be fractured/deformed at baseline. The model will then be trained to distinguish between those fractured/deformed spines that subsequently sustain more fractures or become more deformed and those that stay the same. In the first of these two-class embodiments, the spine to be examined may be unfractured and undeformed whereas in the second two-class embodiment, the spine to be examined may already be fractured and/or deformed. Further information about how the models are prepared is given below.

The embodiments of the models described below use spines that are unfractured and undeformed at baseline. Further reference to unfractured spines also includes reference to undeformed spines. Reference to future fractures also includes reference to future deformity.

The second step is to obtain data representative of the appearance of at least one vertebra of an unfractured spine of a subject. In a preferred embodiment, described below, data representative of the appearance represents the shape of at least one vertebrae of the spine. However, it will be appreciated that data representing the size, texture, image intensity or the thickness of cortical bone visible in the image could also be used, alone or in combination with data representing the shape.

The shape of a vertebra is usually depicted using a six-point representation of a vertebra. The model is then fitted to the data representative of the vertebra and a value calculated that represents the likelihood that the vertebra, or at least one vertebra where the image includes more than one vertebra, may subsequently sustain a fracture.

An example of a one-class model and a two-class model will now be described. The one-class model is built using images of unfractured spines that did not go on to develop spinal fractures within a significant period (e.g. 7-15 years). The two-class model is built using images of unfractured spines where some of the spines are known to maintain structural integrity and some of the spines are known to sustain a fracture in the next few years. Both models may be used to provide a value that indicates the likelihood that a spine being examined will go on to sustain a vertebral fracture. However, the latter has been shown to provide more reliable results as shown below.

The two steps above will now be described in more detail with reference to a specific example.

The embodiment described is based on a case control study using x-rays from 218 post-menopausal women selected from a cohort of Danish women that was followed for assessment of osteoporosis and atherosclerosis in the Prospective Epidemiological Risk Factors (PERF) study. Out of these 218 women, 109 maintained skeletal integrity whereas the other 109 developed one or more vertebral fractures in the course of approximately 5 years. None of the women received treatment for osteoporosis and none experienced an osteoporotic fracture before the baseline visit (including non-vertebral fractures). Cases and controls were matched for age, follow-up time, bone mineral density (BMD) of the lumbar spine and weight.

Lateral x-rays of the lumbar and thoracic spine were obtained at baseline and follow-up and were digitised and analysed by experienced radiologists. All vertebrae that were visible in the x-rays, i.e. L5 to L1, T12 or T11 in the x-rays of the lumbar region, and from L1 or T12 to T4 in the thoracic region, were annotated with at least one vertebra overlapping in each pair of lumbar and thoracic images. The annotations consisted of six points placed on the corners and in the middle of the vertebra end plates, defining the anterior, middle and posterior heights. The lumbar and thoracic parts of the spine are combined by rigidly matching the landmarks of the overlapping vertebra(e) and averaging the double annotated landmarks. All landmark coordinates from the six points on L5 to T4 are used as features in the classification. If data representing other aspects of the appearance of a spine is to be used for the prediction, corresponding information should also be obtained for the spines used to form the model.

A few examples of observed spine shapes are shown in FIG. 1. FIG. 1a shows two randomly selected spine shapes from the group maintaining skeletal integrity and FIG. 1b shows two from the group developing a fracture within the next five years.

Fractures in the follow-up images were identified and graded according to the Genant et al. (“Vertebral fracture assessment using a semi-quantitative technique”—J Bone Miner Res 1993; 8:1137-1148) method of semi-quantitative visual assessment in severity. In this technique, six landmarks are placed on the corners and in the middle point of both vertebra endplates, defining the anterior, middle and posterior heights. According to this method, fractures are indicated as mild if one of the three heights is between 20% and 25% smaller than the maximum of the heights, moderate if the difference is between 25% and 40% and severe if the difference is larger than 40%.

A total of 156 fractures were found in 109 spines at follow up. Of these, 106 were mild fractures, 39 moderate, and 11 severe. If these semi-quantitative scores are added up into an overall spinal deformity index (SDI, sum of individual vertebra scores with normal=0, mild fracture=1, moderate fracture=2 and severe fracture=3), 76 spines had SDI=1 (one mild fracture), 25 had SDI=2 (one moderate or two mild fractures), and 6 had SDI≧3.

The 6-point representations of the vertebrae were aligned in order to eliminate translational and rotational deviations between point sets using Procrustes Alignment. The complex representation of an annotated shape can be defined as:

wᵢ=(x₁+i*y₁,x₂+i*y₂, . . . , xₙ+i*yₙ)^{T}

and generalised Procrustes alignment can be expressed as

wᵢ^{P}=w*ᵢ\hat{μ}wᵢ/w*ᵢwᵢ i=1,2, . . . n

where each wᵢ^{P} is the full Procrustes fit of wᵢ onto \hat{μ}. The full Procrustes estimate of the mean shape [μ] can be found as the eigenvector corresponding to the largest eigenvalue of the complex sum of squares and products matrix:

$$S = {\sum }_{i = 1}^{n} {w}_{i} {w}_{i}^{*} / {w}_{i}^{*} {w}_{i} i = 1 , 2 , … n$$

Each shape was then represented by a feature vector where n is the total number of landmark positions:

x=[x₁,x₂, . . . , x_{N},y₁,y₂, . . . y_{N}]^{t}

The shapes for the one-class model are assumed to be normally distributed. If the model is trained on “normal” shapes only, the Mahalanobis distance to the mean shape can be seen as a measure of abnormality.

To reduce the effect of noise in landmark placement, the procedure of linear point distribution models (PDM) is followed and the shape probability distribution is modeled as a multivariate Gaussian in a subspace of a reduced dimensionality by first applying a principle component analysis (PCA) to the aligned shape vectors. To this end, the mean shape x̅, the covariance matrix Σ, and the eigensystem of Σ, of the model are computed. The eigenvectors φᵢ of Σ provide so-called “modes of shape variation” that describe a joint displacement of all landmarks. The eigenvectors corresponding to the largest eigenvalues λᵢ account for the largest variation; a small number of modes usually captures most of the variation.

This information can then be used in the analysis of an image of an unfractured spine for which it is desired to assess the risk of developing vertebral fractures. In practice, the same landmark positions as were used for the training set are annotated on an image of at least part of a spine. Using the coordinates of these landmark positions, a vector x is calculated. The model is then fit to this vector x according to the following equation:

x= x̅+Φₜb+r

where Φₜ consists of the eigenvectors φ corresponding to the t largest eigenvalues, Φₜ=(φ₁|φ₂| . . . |φₜ), b is a vector of model parameters that specifies the contribution of each of the modes. From this, a vector r may be derived that represents the residual shape variation between the spine to be examined and the model.

As a measure of abnormality an approximation error |r| is used, where the observed shape is approximated by its projection on the PCA subspace derived from the training set of normal shapes. To ensure that the model describes only plausible, normal shapes, the shape parameters of the projected shape are constrained according to:

bᵢ≦k\sqrt{λᵢ}.

The value derived for |r| may be used as a measure of how likely it is that the spine being examined will subsequently suffer vertebral fractures. As |r| increases (and therefore the difference between the actual spine and the model increases) the likelihood that vertebral fractures will be suffered increases.

In an alternative embodiment, where the one-class model is made using unfractured spines that are known to subsequently sustain fractures, the likelihood that the spine being examined will subsequently sustain vertebral fractures increases as |r| decreases.

A preferred embodiment of the two-class model is prepared and trained using information derived from both classes of vertebrae—i.e. those that are known to maintain structural integrity and those that are known to sustain a fracture in a pre-determined number of years. A discriminant approach is used where the model is then able to distinguish between the two classes for new spines.

A classifier can be written in terms of the discriminant functions dᵢ, that provides a direct measure of the probability that a spine is going to fracture. Again, feature vector x is calculated for each shape and using information from the follow-up images about whether or not a fracture is sustained each shape is assigned the class that corresponds to the largest dᵢ(x). A 0-1 loss function is assumed, i.e. false positives and false negative detections are equally bad—such that the optimal discriminant function that minimises risk is:

dᵢ(x)=p(x|wᵢ)P(wᵢ)

That is, each object should be assigned the class that maximises the posterior probability. wᵢ represents the different classes. P(wᵢ) is the prior probability of belonging to class wᵢ.

Assuming multivariate Gaussian distributions p(x|wᵢ) and, to reduce the complexity of the model and therefore the risk of over fitting to the data in the case of a relatively small dataset, assuming that both distributions have equal covariance, the resulting optimal classifier is the linear discriminant classifier:

dᵢ(x)=ln P(wᵢ)−½[(x−μᵢ)^{T}Σ⁻¹(x−μᵢ)]

where Σ is the pooled covariance matrix, i.e. the average covariance matrix weighted by the class prior probabilities.

In the experiments performed by the inventors a regularised linear discriminant classifier was used and Σ was replaced with Σ′:

Σ′=(1−α)Σ+ασ²I

where I is the identity matrix, σ² is the mean variance, and α a regularisation parameter with 0≦α≦1. Σ′ represents a linear weighting between the empirical covariance recorded (Σ) and the choice of the identity covariance matrix. The latter can be thought of as a lesser committed choice. Σ′ represents a simpler covariance structure than the one that the recorded data empirically exhibits. Varying α makes the classifier vary between the non-regularised linear discriminant classifier and the nearest mean classifier weighted by the class prior probabilities. A suitable value for α depends on the number of features and training samples and on the distribution of the data. Where α is equal to 0 the result depends entirely on the empirical data. Where a limited amount of training data is available, α may be closer to 1. A value for α may be selected using cross-fold validation on the training set.

The only variable left in the equations above is the feature vector x. This is calculated from the image of the spine being examined, using information of co-ordinates from the annotated landmark positions. The model is fit to the data representing the image of the spine being examined by adding this vector value to the equation to enable a calculation of dᵢ and to provide an indication of the likelihood that the spine belongs to the class that is likely to sustain vertebral fractures. Specifically, dᵢ gives the probability that the spine being examined belongs to the class i.

Both methods have been described with reference to analysis of an image of part of a spine. It will be appreciated that this can extend to the whole spine or to a single vertebra. For example, if an image of a single vertebra is to be examined, information from the model about the corresponding vertebra can be used to calculate dᵢ or |r| to obtain a value representative of the likelihood of that vertebra sustaining a fracture.

To test the models, a set of leave-one-out experiments was performed in which the classifiers for each shape were trained on the remaining 217 shapes. For the one-class classification, only the group maintaining skeletal health was used for training. Since the size of the spine could carry important information on fracture risk, the shapes are aligned using Procrustes alignment with translation and rotation, without scaling. The regularised linear discriminant classifier described above is used with α set to 0.1. For the one-class model, the number of modes selected was t=10 and shape parameters were constrained with k=3.

FIG. 2 illustrates the shape variation of spines across the classification boundary, in particular showing mean unfractured spine shape 10, an unfractured spine likely to fracture 12 and an unfractured spine likely to stay in tact 14. The discriminating shape variation is a complex combination of various changes; prominent features seem to be an overall accentuation of the spinal curve and slight enlargement of the intervertebral spaces in the lumbar area.

The difference between the two groups at baseline is significant with p=6.1×10⁻⁵ in a Wilcoxon rank sum test. Future fracturing of the spine is predicted with an accuracy percentage correct classification) of 0.67 and area under the ROC curve (AROC) of 0.66. At a sensitivity of 76% fractures were predicted with a specificity of 72%. If the same classifier, trained on the same data, is applied to discriminating (SDI≧2) from normal based on the baseline shape, accuracy is 0.71, AROC=0.71, p=2.0×10⁻⁶. These results are shown in the ROC curves of FIG. 3.

The one-class model, trained on the normal subjects only, performs slightly worse with accuracy=0.56, AROC=0.63, p=5.9×10⁻⁴.

The above described method uses a six-point representation of vertebrae. However, it will be appreciated that a full contour of the vertebrae may be depicted and would likely provide improved results. In this respect, one shortcoming of the six-point representation may be that osteophytes and more subtle vertebral shape variations can not be captured. In vertebral fracture classification, use of a full contour representation seems to give a slight improvement with respect to convention height measurements. Accordingly, a similar improvement can be expected if a full contour annotation is used in the method described above. Alternatively, corner points only or vertebra centre points could be used in place of or in addition to the six-point representation to obtain useful results.

In the embodiment described above, annotation of the vertebrae is performed manually. Although this is common practice in current quantitative morphometry studies, in a preferred embodiment, annotation of the vertebrae would be automatic.

The above described two-class embodiment, uses linear discriminant analysis. It will be appreciated, however, that any discriminant analysis or classifier, e.g. quadratic discriminant analysis or non-parametric classifiers could be used to achieve similar results. The discriminant analysis may alternatively be in the form of penalised discriminant analysis or by using robust estimates for the covariance matrix. Further information about the forms of training that may be used can be found in the paper by De la Torre, F. and Black, M. J “A framework for robust subspace learning”, International Journal of Computer Vision, Vol. 54, Issue 1-3, pp 117-142, August-October 2003.

A further example of the invention, this time using a non-linear classifier was carried out as described below.

The skeletal and demographic characteristics of the study population used in this example are presented in Table 1.

TABLE 1
Demographic characteristics of the study population at baseline.

| Characteristics (p-values | | | | |
|---|---|---|---|---|
| obtained by Mann-Whitney | | | | |
| Ranksum test between cases and | | | | |
| controls at baseline). Average | Controls | | Cases | |
| follow up period: 6.3 Years. | (n = 101) | | (n = 25) | |
| Age (p = 0.98) | 66.6 | (5.9) | 66.9 | (5.4) |
| Years Since Menopause | 17.71 | (8.0) | 19.0 | (8.2) |
| (p = 0.56) | | | | |
| Height (cm) (p = 0.21) | 161.8 | (6.0) | 163.5 | (4.46) |
| Weight (Kg) (p = 0.53) | 65.4 | (8.4) | 68.3 | (11.7) |
| BMI, Kg/m² (p = 0.72) | 25.01 | (3.2) | 25.5 | (4.0) |
| Baseline Spine BMD, g/cm2 | 0.8551 | (0.14) | 0.8061 | (0.14) |
| (p = 0.2) | | | | |
| Distribution of fractures at | | | | |
| Followup | | | | |
| L1 | 0 | | 15 | |
| L2 | 0 | | 5 | |
| L3 | 0 | | 1 | |
| L4 | 0 | | 4 | |
| Mild | 0 | | 4 | |
| Moderate | 0 | | 15 | |
| Severe | 0 | | 6 | |
| Number of Fractures at | | | | |
| Followup: | | | | |

| | | |
|---|---|---|
| 1 | 0 | 25 |
| 2 | 0 | 0 |
| 3 | 0 | 0 |

Results are shown in mean ± SD format.

The population investigated was chosen from the PERF cohort, described previously in detail (Bagger et al). The study population consisted of 126 healthy post menopausal women in the baseline from which 25 (cases) sustained at least one lumbar fracture before the follow up visit within a 5 to 8 year period, where as the other 101 (controls) subjects maintained skeletal integrity in the afore mentioned observation period. To identify these patients, data of 4062 women first screened between 1992 and 1995 (baseline) and re-examined between 2000 and 2001 (follow up) were reviewed. In this population, there were a total of 662 patients who sustained at least one new vertebral fracture in the follow up, of whom 88 did not have a fracture at baseline. Out of these 88 subjects, 25 had a vertebral fracture in the Lumbar region only. We selected these 25 individuals and matched them with a control group with comparable age, BMI, spine BMD, smoking habit, and self-reported physical exercise to establish a case-control setting. At baseline, none of the 126 subjects had a vertebral fracture or displayed any sign of disorders of calcium metabolism or bone disease, or took any medication known to affect bone metabolism.

The following nomenclature is used to differentiate between groups of subjects in the study: (a) HH1: the group of subjects at baseline who would not sustain vertebral fracture at the follow up, (b) HH2: the group of the same subjects as in HH1 but at the follow up, (c) HF1: the group of subjects at baseline who would sustain at least one fracture in the spine region in the follow up, (d) HF2: the group of same subjects as in HF1 but at the follow up.

X-rays of the thoracic and the lumber region were taken for each of the subjects at baseline and follow up. In the lateral position, pillows were used in order to ensure good alignment of the vertebral bodies. The distance between the focal plane and the film was kept constant at 1.2 m and the central beam was directed to T7 when the thoracic spine was examined and to L2 when the lumbar spine was investigated.

The anterior-posterior radiographs were regularly taken for general view and assessment of vertebral deformities, whereas the fracture assessment was performed on lateral radiographs. All lateral radiographs were digitized at 570 DPI and posteriorly analyzed by a specialist in radiology (PP) with more than 10 years experience. The X-rays were classified, reevaluated and confirmed for the presence of fractures according to Genant's semi-quantitative method. For further analysis of the images, six points, called the height points, were placed at the corners and at the middle points of the vertebral endplates, by the same radiologist using a computer program. Furthermore a detailed quantitative morphological analysis was performed where a hard threshold of 0.8 on the ratio of the minimum and maximum of the three (anterior, posterior and middle) vertebral heights was used to detect any possible fracture which was missed by the semi-quantitative method. This quantitative analysis was performed using both baseline and follow up X-rays. The basic scheme of the computer based analysis used to compute VDS is detailed below.

### Step 1 (Vertebra Selection):

The vertebra with maximum difference in heights (most deformed) computed using the above mentioned 6-point annotations was chosen for each of the 126 subjects both from the baseline and the follow up X-rays. The chosen vertebrae were from T12 to L5. The three heights as defined by the six-point annotations of this most deformed vertebra were ‘normalized’, such that the average of them was unity for any given individual. This normalization compensated for the variations in vertebral heights due to any possible inconsistency in the imaging protocol and/or due to the variance of the physical size (height, breadth etc) of the individuals. The maximum and minimum of these three normalized heights of the chosen vertebrae were used to compare individuals belonging to different groups, viz., cases and controls at baseline and follow up, in the way described below and we call them the ‘feature heights’.

### Step 2 (Construction of Classifier and VDS Computation):

In order to differentiate between subjects based on the baseline measurements, a quadratic classifier (Duda et al, pages 6-11, 19-29) was built using the feature heights of the subjects belonging to HH1 and HF1.

Each selected vertebra was represented by the maximal (Hₘₐₓ) and minimal (Hₘᵢₙ) of its three vertebral heights (anterior, medial, posterior) normalized to unit average height in each vertebra, i.e. the sum of all three heights were always set, or adjusted, to equal 3.

Hₘₐₓ=max (Hₐₙₜ, H_{med}, Hₚₒₛₜ)/mean(Hₐₙₜ, H_{med}, Hₚₒₛₜ),

Hₘᵢₙ=min (Hₐₙₜ, H_{med}, Hₚₒₛₜ)/mean(Hₐₙₜ, H_{med}, Hₚₒₛₜ)

Evidently Hₘₐₓ≧1.0 and Hₘᵢₙ≦1.0 for any vertebra. The relation between Hₘₐₓ, Hₘᵢₙ and Genant's height ratio is illustrated in FIG. 5. The selected vertebrae are divided into two classes: those from subjects sustaining an incident fracture during the study and originating from subjects remaining skeletal integrity. Vertebral heights in each class was assumed normally distributed (following a multivariate normal distribution in Hₘₐₓ, Hₘᵢₙ identified by the empirical class mean and linear covariance matrix):

P_{frac} (Hₘₐₓ, Hₘᵢₙ)=n(μ_{frac},Σ frac)

P_{healthy} (Hₘₐₓ, Hₘᵢₙ)=n(μ_{healthy},Σ healthy)

For any new vertebra, the relative likelihood

P_{frac} (Hₘₐₓ, Hₘᵢₙ)/((P_{frac} (Hₘₐₓ, Hₘᵢₙ)+P_{healthy} (Hₘₐₓ, Hₘᵢₙ))

of belonging to the fracture class was computed from these normal distributions. This relative likelihood ratio was the Vertebra Deformity Score. It is a number between 0 and 1 representing the probability of sustaining a fracture. The VDS for all patients were computed in a leave one out procedure to avoid bias and underestimation of the variance.

In FIG. 5 we illustrate how the shapes of the vertebrae would look in the space of normalized heights where the classifier was constructed, assuming that the maximum and the minimum normalized heights are the posterior and the anterior ones though in the actual data this is not the case. Hence the shapes of the vertebrae in FIG. 5 are for illustrative purposes only. To assess the risk of a given individual of sustaining a fracture, the VDS was computed using the posterior probabilities based on the aforementioned classifier and for baseline subjects this was performed in a leave one out fashion in order to separate test from training. More specifically for the baseline subjects, the prediction system, viz., the classifier in FIG. 5, was constructed by using the baseline measurements of all the 126 subjects except for one. The left out subject was then used as a test case for which the VDS was computed. The procedure is repeated by considering each of the 126 individuals as the left out (test case) one. This leave-one-out (LOO) procedure is free from any bias towards the subject whose fracture risk is computed. Conceptually the VDS is the chance of a given subject to belong to the group represented by the crosses in FIG. 5.

We also investigated the performance of traditionally used height ratios (ratio between the minimum and maximum of the three vertebral heights) as a prognostic marker for fracture prediction in two different settings. The mean height ratio (MHR) between T12-L5 vertebrae and the height ratio of the most deformed (MDHR) vertebra of each of the subjects were used as the scores of fracture risk in these two different approaches. However, use of height ratio as a continuous measure for fracture prediction in the absence of any prevailing fracture to our knowledge is also a novel approach proposed in this study.

Furthermore we compared the performance of VDS with that of the best previously known in the field of image based prognostic markers for vertebral fracture prediction viz., the irregularity measure previously proposed in Pettersen et al, through an analysis of the area under the ROC curve (AROC).

The results are presented in the mean±SEM format unless otherwise specified. The VDS of different groups of subjects were compared using the non-parametric Mann-Whitney U test. Differences were considered statistically significant, if the p values were less than 0.05.

A bootstrap analysis was performed to investigate whether the fracture risk can be localized at the vertebrae level. The VDS of the vertebrae, which got fractured in the follow up, were compared 1000 times through Man-Whitney U tests with that of the similar number of randomly chosen vertebrae which remained healthy through out the observation period. If the number of times the difference was statistically significant was greater than 500, then it was concluded that the mean fracture risk for the vertebrae which did not fracture in the follow up was significantly different from that of those which got fractured.

The p-values to detect statistically significant difference in performance between VDS and the irregularity fracture risk measures was computed using Delong's method.

FIG. 4 shows the result of a statistical analysis based on the VDS computed using the classifier built on the training data from HH1 and HF1 classes, as illustrated in FIG. 5. For HF1 and HH1 the VDSs are calculated in a leave-one-out fashion in order to avoid introduction of any bias. The VDS is significantly higher at the baseline for the subjects which were going to sustain fracture at the end (follow up) of the observation period and the significance also increased with the incidence of fractures, as is apparent from the comparison between cases at baseline and follow up. There was a statistically significant difference between the risk of sustaining a vertebral fracture in the Lumbar region, the VDS, between the subjects in HF1 and HH1 (0.67±0.04 vs. 0.35±0.03, p<10⁻⁶). The incidence of a fracture increased the risk in HF2 (0.99±0.0052 vs. 0.67±0.04, p<10⁻⁸) when compared to HF1. In the follow up the fracture risk was also significantly higher in HF2 when compared to HH2 (0.44±0.03 vs. 0.99±0.0052, p<10⁻¹³). A marginal statistically significant difference in the VDS of HH1 and HH2 was also observed (0.35±0.03 vs. 0.44±0.03, p=0.04).

FIG. 2 illustrates the shape of the vertebrae corresponding to different partitioning of the plane spanned by the minimum and the maximum normalized heights. A high VDS implies that the datum lies in the upper left region. The dashed line denoted VDS is a classification boundary constructed using the measurements on the subjects at baseline. The crosses denote the HF1. The HH1 class is represented by the dots. The dots in the centres of the ellipses are the mean of the measurements in each class. The ellipses depict the spread (standard deviation) of the data in the respective classes. The solid line (denoted MDHR=0.8) represents the subjects who have MDHR=0.8. The dashed line (denoted MDHR=0.8506) is the optimal decision boundary if MDHR of the subjects are used in the classification.

Dividing the risk scores into tertiles the odds ratio for the high risk subjects at baseline was 35.7 as depicted in FIG. 6. The area under the ROC curve was 0.82.

The odds ratio for high risk patients yielded by VDS was higher (though not statistically significant) than that produced by MHR and MDHR as shown in FIG. 6.

As all the subjects at baseline did not have any fracture, the Genant's semi-quantitative score yielded an odds ratio of 1. We see that performance of the VDS is significantly better than that of Genant's semi-quantitative score. However height ratios between the minimum and maximum of the three vertebral heights as continuous scores, as used in MHR and in MDHR, also performed well in predicting fractures. The 95% confidence intervals are also shown as CI:[ . . . ]. The area under the ROC (AROC) of VDS was significantly higher than that of the irregularity measure (AROC: 0.82 vs. 0.67, p=0.02) as depicted in FIG. 7 which shows a comparison of VDS with irregularity measure by analysis of the area under the ROC (AROC) curves. The performance of VDS is significantly better than that of the irregularity measure. The odds ratios for the high risk patients were 35.7 and 3.2 yielded by the VDS and the irregularity measure respectively.

Percentage of vertebrae with maximum difference in heights in HF1 as chosen for computation of VDS, which fractured in the follow up is less than 25. In order to investigate further whether the fracture risk can be localized at the vertebrae level using VDS, we performed bootstrap statistical analysis between the group of vertebrae which were going to fracture with that of which were not. No statistically significant difference was found.

Inspecting radiographs of two subjects in HF1 with the highest and the second highest VDS visually no abnormality in the vertebral shape can be detected when compared to the Lumbar region of a healthy spine.

Thus, we used a computer based classifier to predict Lumbar vertebral fractures in post menopausal women by using the vertebral height difference in the lumbar spine, independent of BMD and the other major risk factors for osteoporosis. We found that the classifier was able to differentiate the subjects who would sustain at least one Lumbar vertebral fracture from those who maintained integrity. The method was also able to separate the subjects in the fracture group differentiating the baseline and the follow up indicating a higher risk for future fractures. The comparison between the baseline and follow up of the healthy population showed also an increasing risk for sustaining fracture in this group. The classifier was however not able to predict which vertebrae would fracture. Comparing the results obtained from the classifier considering the whole population in the baseline and Genant's semi quantitative method, a very significant difference was found. The proposed prognostic marker outperformed the irregularity measure. The performances of mean height ratio (MHR) and height ratio of the most deformed vertebrae, also proposed as continuous prognostic marker for osteoporotic fragility fracture prediction, were also found to be very promising.

The VDS computed by our classifier showed also an increased risk for sustaining the second fracture in the HF group as it showed a significant difference between HF1 and HF2. Lunt et al assessed the risk of an incident fracture by correlating the presence of prevalent deformities in adjacent vertebral bodies. This showed that the risk of a subsequent vertebral fracture in these individuals varied according to the severity of the deformities. When a vertebra is fractured it shows an increase in the difference of the heights which means that the grade of deformity is also increased which is easily determined by the classifier used in our study. However when the fractured vertebrae in the subjects belonging to HF2 were excluded from the analysis no significant difference between VDS of HF1 and HF2 was found.

There was also a significant difference in the HH1 and HH2 groups pointing to an increasing risk for an incident fracture. To explain this difference we need to consider the aging process and the diminishing in the muscle strengths. The primary motions, disc pressures, facet loads, and disc fibre strains are all affected by postural changes and the changes in lordosis markedly affect the stabilizing sagittal moments. With aging the postural changes in the lumbar spine are inevitable and as the thoracic spine becomes more kyphotic, the lumbar assumes a more erect positioning, losing its convexity. Also, the degeneration of the discus reflected by a diminishing of the inter-vertebral spaces also contributes to the cited changes.

The fact that our classifier showed a significant difference when compared to Genant's semi-quantitative method in the baseline groups, where all the subjects were healthy can be easily explained. The classifier just takes into account the measure of the heights independently of a visual analysis of the vertebrae while the semi-quantitative method proposed by Genant also considers a visual approach performed by a radiologist. This analysis judges the deformity not just with the estimated assessment of the height reduction, but also by the visual inspection of morphologic changes. A radiologist while analyzing a radiograph takes into account positioning, obliquity, scoliosis and several differential diagnoses for vertebral deformity before performing the measurement of the vertebral heights. In our analysis the classifier detected all the deformities without taking into account remodeling of vertebrae, poor positioning, etc.

The continuous nature of VDS computed by the classifier also opens up the possibility of grading the severity of the risk by applying appropriate thresholds. The performance of VDS, MDHR and MHR were also found to be promising in predicting vertebral fracture in the thoracic region.

In summary, the classifier can predict the subjects in risk for sustaining the first Lumbar vertebral fracture independent of BMD and classical risk factors. Changes in the difference of heights provide a simple and efficient method of identifying vertebrae that could lead to an unstable spine and therefore increase the risk for sustaining a vertebral fracture. It is therefore a useful tool in clinical trials investigating drugs for treatment and prevention of osteoporosis and fractures.

In this specification, unless expressly otherwise indicated, the word ‘or’ is used in the sense of an operator that returns a true value when either or both of the stated conditions is met, as opposed to the operator ‘exclusive or’ which requires that only one of the conditions is met. The word ‘comprising’ is used in the sense of ‘including’ rather than in to mean ‘consisting of’.

### REFERENCES

[1] Y. Z. Bagger, L. B. Tanko, P. Alexandersen, H. B. Hansen, G. Qin and C. Christiansen, The long-term predictive value of bone mineral density measurements for fracture risk is independent of the site of measurement and the age at diagnosis: results from the Prospective Epidemiological Risk Factors study. Osteoporosis International 17, 471-477 (2006).
[2] R. O. Duda, P. E. Hart and D. G. Stork, Pattern Classification, Wiley-Interscience, 2000.
[3] P. C. Pettersen, M. de Bruijne, J. Chen, Q. He, C. Christiansen and L. B. Tanko, A computer-based measure of irregularity in vertebral alignment is a BMD-independent predictor of fracture risk in postmenopausal women. Osteoporos Int (2007).
[4] E. R. DeLong, D. M. DeLong and D. L. Clarke-Pearson, Comparing the areas under two or more correlated receiver operating characteristic curves: a nonparametric approach. Biometrics 44, 837-845 (1988).
[5] M. Lunt, T. W. O'Neill, D. Felsenberg, J. Reeve, J. A. Kanis, C. Cooper and A. J. Silman, Characteristics of a prevalent vertebral deformity predict subsequent vertebral fracture: results from the European Prospective Osteoporosis Study (EPOS). Bone 33, 505-513 (2003).

1. A method of estimating the risk of future fracture or deformity of vertebrae of a spine by processing data derived from an image of at least one vertebra of a spine, comprising the steps of:
comparing data representing the appearance of the at least one vertebra with a statistical model of a corresponding part of a spine, the statistical model being formed from data representing images of spines for which information about the degree of fracture or deformity of each spine at a subsequent time is known;
deriving a measure of the similarity between the at least one vertebra of the spine and the model, wherein said measure is representative of the likelihood that the spine will subsequently sustain a fracture or become deformed.

2. A method as claimed in claim 1, wherein the statistical model is formed from data representing images of unfractured and undeformed spines for which it is known whether vertebrae of said unfractured and undeformed spines remain unfractured and/or undeformed until the subsequent time.

3. A method as claimed in claim 2, wherein the statistical model is trained to distinguish between a class of unfractured and undeformed spines that remained unfractured and undeformed until said subsequent time and a class of unfractured and undeformed spines that sustained one or more fractures or became deformed by said subsequent time.

4. A method as claimed in claim 3, wherein the measure is representative of the probability that the spine belongs to the class of unfractured and undeformed spines that sustained one or more fractures or became deformed by said subsequent time.

5. A method as claimed in claim 1, wherein the statistical model is formed from data representing images of fractured and/or deformed spines for which it is known whether the fractured and/or deformed spines sustain further fractures and/or become more deformed by the subsequent time.

6. A method as claimed in claim 5, wherein the statistical model is trained to distinguish between a class of fractured and/or deformed spines that do not sustain further fractures or become more deformed by said subsequent time and a class of fractured and/or deformed spines that sustain further fractures or become more deformed by said subsequent time.

7. A method as claimed in claim 6, wherein the measure is representative of the probability that the spine belongs to the class of fractured and/or deformed spines that sustain further fractures or become more deformed by said subsequent time.

8. A method as claimed in claim 2, wherein the model is trained using supervised learning.

9. A method as claimed in claim 2, wherein the model is trained using discriminant analysis.

10. A method as claimed in claim 1, wherein the statistical model is trained using unfractured and undeformed spines that remained unfractured and undeformed until said subsequent time.

11. A method as claimed in claim 10, wherein the measure is representative of the difference between the spine and the statistical model and the likelihood that the spine will sustain a fracture and become deformed increases as the measure increases.

12. A method as claimed in claim 1, wherein the statistical model is trained using unfractured and/or undeformed spines that sustain fractures or become deformed by said subsequent time.

13. A method as claimed in claim 12, wherein the measure is representative of the difference between the spine and the statistical model and the likelihood that the spine will sustain a fracture and/or become deformed increases as the measure decreases.

14. A method as claimed in claim 1, wherein processing data comprises processing data representing the appearance of two or more adjacent vertebrae of a spine and wherein said measure represents the likelihood that at least one of said vertebrae will subsequently sustain a fracture and/or become deformed.

15. A method as claimed in claim 1, wherein said data representing the appearance of the at least one vertebra comprises data representing one or more of the shape, image texture, thickness of cortical bone visible in the image and image intensity.

16. A method as claimed in claim 1, wherein said data representing the appearance of the at least one vertebra comprises data representing the shape of the at least one vertebra.

17. A method as claimed in claim 16, wherein said data representing the appearance of the at least one vertebra further comprises one or more of the image texture, thickness of cortical bone visible in the image and image intensity.

18. A method as claimed in claim 1, wherein comparing the data with the statistical model comprises fitting the model to the data.

19. A method of characterising an image of at least one vertebra of a spine to determine if the image belongs to a class of images of spines for which the degree of fracture and/or deformity does not change by a subsequent time, comprising the steps of:
comparing data representing the appearance of the at least one vertebra with a statistical model of a corresponding part of spine, the statistical model being formed from data representing images of spines for which it is known whether vertebrae of the spines sustained fractures or became deformed by the subsequent time;
deriving a measure of the similarity between the data representing the at least one vertebra and the statistical model, wherein the measure is representative of the likelihood that the image of the at least one vertebra belongs to the class of images of spines for which the degree of fracture and/or deformity did not change by the subsequent time.

20. A method as claimed in claim 19, wherein the statistical model is a linear classifier.

21. A method as claimed in claim 19, wherein the statistical model is a non-linear classifier
